(19) United States
(12) Patent Application Publication
(10) Pub. No.: US 2003/0169297 A1
(43) Pub. Date: Sep. 11, 2003

(54) Method and data processing system for notifying a user whether a printer is ready to print

(76) Inventors: D. Travis Lay, Meridian, ID (US); Bradley J. Anderson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/092,189

(22) Filed: Mar. 6, 2002

(51) Int. Cl. G09G 5/00

(52) U.S. Cl. 345/772

(57) ABSTRACT

A first indicator is displayed to a computer user to indicate that a specified output device is warmed up and ready to print, while a second indicator is displayed to the user when the output device is not warmed up and ready to print. Preferably, the indicators are GUI icons or buttons, and the first indicator differs from the second by color, with one color being utilized to indicate “ready”, and another to indicate “not ready”. Then, when an output device is not yet ready to print, the user may select and activate the indicator in order to warm up the output device in advance of the user's need to print.

### FIELD OF THE INVENTION

The present invention generally relates to printer interfaces and, more specifically, to a Graphical User Interface (GUI) printer interface that provides an indication of whether or not a printer is warmed up ready to print.

### BACKGROUND OF THE INVENTION

Printing in a typical computer system is typically controlled by the operating system. When using a Graphical User Interface (GUI) operating system, such as Windows from Microsoft® or Macintosh® from Apple®, a user will select printing, typically through either a menu option or by depressing a button on a button bar. A printer driver will then format the requested printing for the selected printer and queue the printing in a print spool for printing. The printer driver will then download the printer commands that will result in printed pages being sent to the selected printer.

Printer drivers are typically either supplied to computer users by the printer vendor or by the operating system vendor. Since the sophistication of a printer driver user interface can help sell printers, printer vendors have produced ever more sophisticated printer drivers and printer driver interfaces. Some of the features currently available in printer drivers and printer driver interfaces include: printing a single page of a document, the entire document, or a range of pages in the document; printing multiple copies of a document; printing the pages in a document in reverse order; printing multiple pages of a document on a single sheet of paper; landscape and portrait printing; printing on different page sizes; printing labels; duplex printing where both sides of a page are printed; and printing with watermarks.

In the Windows operating systems from Microsoft, these different types of printing and printing options are typically selected by first selecting printing from either the “File” menu, or by selecting a Printer button. This launches a “Printer” menu. The typical printer options for a user are typically set to a default for that user. If he should wish to change any of them for a particular document, he can select “Properties” from the Printer menu. This typically will launch a printer or vendor-specific Printer Properties menu or set of menus. A Printer Properties menu is alternatively launched by selecting “Printer Properties” from the “Print” menu launched from the “File” pull-down menu of many applications. The user can then make any changes he requires from the Printer Properties set of menus.

Many printers and other output devices need to be hot, or at least warm, in order to print. This is currently particularly true for laser printers which utilize fusing rollers to melt toner into paper being printed. Presently, this is most notable with higher end color laser printers that may take 5-10 minutes to warm up before they can print.

The result is that, when a user initiates printing on an output device that needs to warm up before printing, the user may have to wait for the output device to warm up before his printing can occur. It would be advantageous if this output device warm-up time, if present, could be overlapped with other user tasks so that a user would be able to immediately print to an output device when he is ready to do so.

### BRIEF SUMMARY OF THE INVENTION

A first indicator is displayed to a computer user to indicate that a specified output device is warmed up and ready to print, while a second indicator is displayed to the user when the output device is not warmed up and ready to print. Preferably, the indicators are GUI icons or buttons, and the first indicator differs from the second by color, with one color being utilized to indicate “ready”, and another to indicate “not ready”. Then, when an output device is not yet ready to print, the user may select and activate the indicator in order to warm up the output device in advance of the user's need to print.

### BRIEF DESCRIPTION OF THE DRAWINGS

FIG. 1 is a block diagram illustrating an exemplary General Purpose Computer in a data processing system;

FIG. 2 is a diagram illustrating an exemplary laser printer, in accordance with an embodiment of the present invention;

FIG. 3 is a block diagram illustrating the printer controller shown in FIG. 2;

FIG. 4 is a diagram illustrating a GUI environment desktop screen showing an application program screen, in accordance with an embodiment of the present invention;

FIG. 5 is a diagram illustrating a GUI environment desktop screen showing a Printer Properties menu, in accordance with an embodiment of the present invention;

FIG. 6 is a diagram illustrating a GUI environment desktop screen showing a Printer Properties menu, in accordance with an embodiment of the present invention; and

FIG. 7 is a flowchart illustrating an implementation of the present invention.

### DETAILED DESCRIPTION OF THE INVENTION

A first indicator, such as a green menu button or icon showing a printer, is displayed on the screen of a computer to indicate that a specified output device is currently warmed up and ready to print, while a second indicator, such as a red menu button or icon showing a printer, is displayed when the output device is not yet warmed up and ready to print. Also, whenever the output device is not yet ready to print, the user may select and activate the menu button or icon in order to warm it up in advance of the user's need to print. This provides an indication to the user that his printer is not warmed up and ready to print, and also provides him with the ability to command that printer to warm up in anticipation of a future request to print.

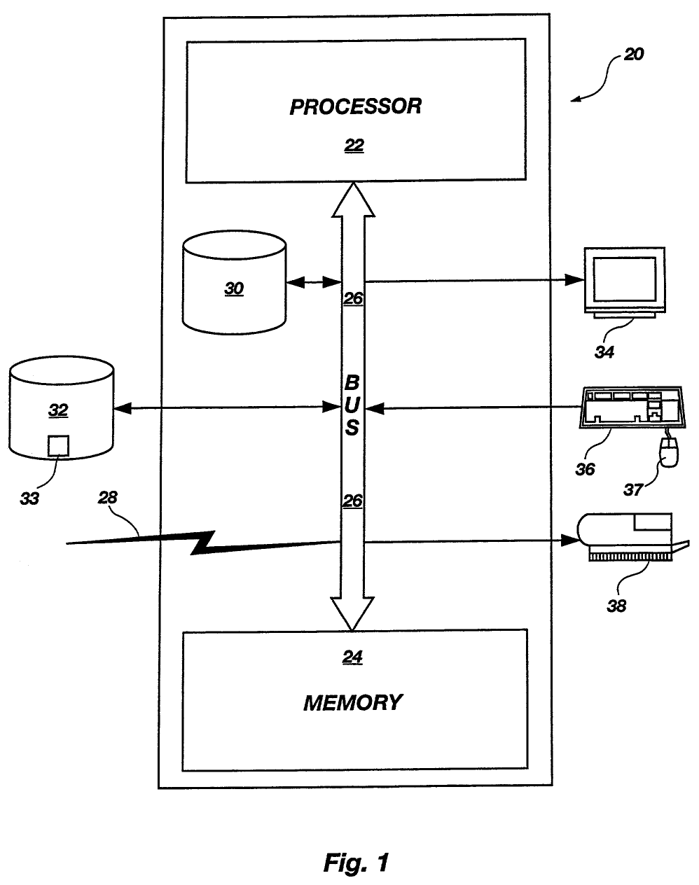

FIG. 1 is a block diagram illustrating an exemplary general purpose computer 20 in a data processing system. The general purpose computer 20 has a computer processor 22 and memory 24, connected by a bus 26. Memory 24 is a relatively high-speed, machine-readable medium and includes volatile memories, such as DRAM and SRAM, and non-volatile memories, such as ROM, FLASH, EPROM, and EEPROM. Also connected to the bus 26 are secondary storage 30, external storage 32, output devices such as a monitor 34, input devices such as a keyboard 36 (with mouse 37), and printers 38. Secondary storage 30 includes machine-readable media such as hard disk drives (or DASD) and disk sub-systems. External storage 32 includes machine-readable media such as floppy disks, removable hard drives, magnetic tapes, CD-ROM, and even other computers, possibly connected via a communications line 28. The distinction drawn here between secondary storage 30 and external storage 32 is primarily for convenience in describing the invention. As such, it should be appreciated that there is substantial functional overlap between these elements. Computer software such as printer drivers, operating systems, and application programs can be stored in a computer instruction storage medium, such as memory 24, secondary storage 30, or external storage 32. Executable versions of computer software 33 in the form of computer instructions can be read from a computer readable medium such as external storage 32, secondary storage 30, and non-volatile memory and loaded for execution directly into volatile memory, executed directly out of non-volatile memory, or stored on the secondary storage 30 prior to loading into volatile memory for execution.

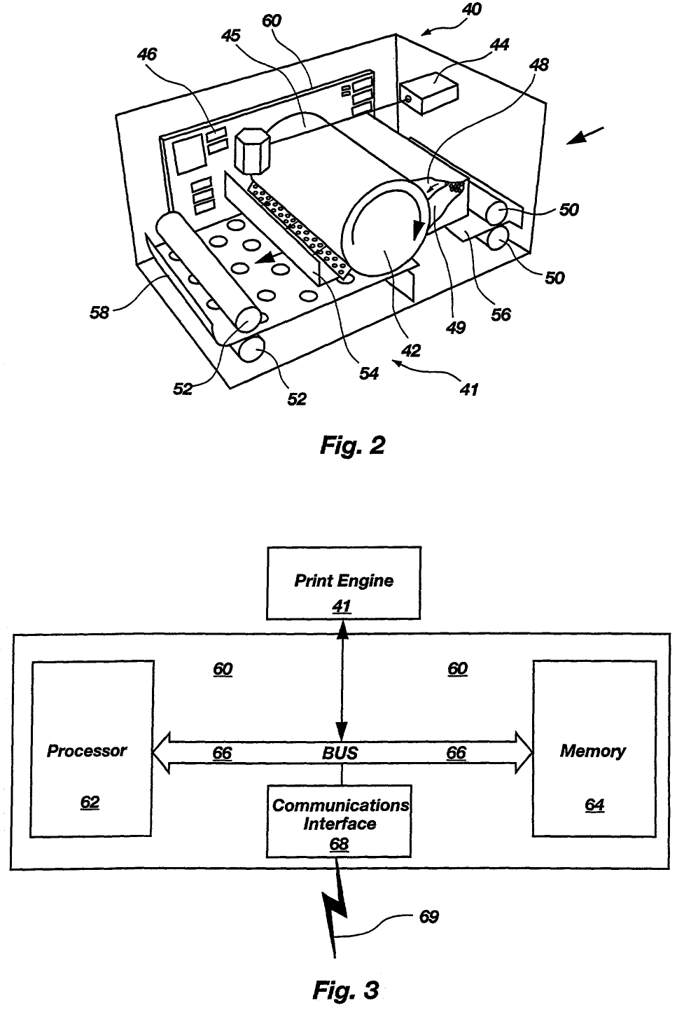

FIG. 2 is a perspective view of the internal structure illustrating an exemplary laser printer 40, in accordance with an embodiment of the present invention. Such a laser printer is shown in FIG. 1 as an exemplary printer 38. In printing a page on a laser printer 40, print information is transferred across a communications link 69 (see FIG. 3) to a printer controller 60. In the printer controller 60, the image is converted into a bitmap image corresponding to dots on the page to be printed. A letter sized page printed at 600 dots per inch results in over 30 million dots. This bitmap image of dots to be printed is stored in the memory of the printer controller 60.

The remainder of the laser printer 40 (excluding the printer controller 60) comprises the printer engine 41. At the heart of the laser printer 40 is a small rotating drum 42—an organic photo-conducting cartridge (OPC)—with a coating that allows it to hold an electrostatic charge. A laser beam 45 scans across the surface of the drum 42, selectively imparting points of positive charge onto the drum's surface that will ultimately represent the output image. The selective charging is done by turning the laser 44 on and off as it scans the rotating drum 42, using a complex arrangement of spinning mirrors 46 and lenses. The printer controller 60 controls the laser 44 and the spinning mirrors 46 to charge a pattern on the drum 42 corresponding to the bitmap of dots stored in its memory.

The area of the drum is the same as that of the paper onto which the image will eventually appear, every point on the drum corresponding to a point on the sheet of paper 58. In the meantime, the paper 58 is passed through an electrically charged wire (not shown), which deposits a negative charge onto it.

Inside the printer, the drum 42 rotates to build one horizontal line at a time. As the drum 42 rotates to present the next area for laser treatment, the written-on area moves into the laser toner 48. Toner is very fine black powder, negatively charged so as to cause it to be attracted to the points of positive charges on the drum 42 surface. Toner is typically applied to the drum 42 by use of a toner roller 49. Thus, after a full rotation, the drum's surface contains the whole of the required black image.

A sheet of paper 58 now comes into contact with the drum 42, fed in by a set of rubber rollers 50. As the drum 42 completes its rotation, the toner is transferred from the drum 42 to the paper 58 by virtue of its magnetic attraction, thereby transferring the image to the paper 58. Negatively charged areas of the drum 42 don't attract toner and result in white areas on the paper 58. Toner is specially designed to melt very quickly. A fusing system consisting of fusing rollers 52 now applies heat and pressure to the imaged paper 58 in order to adhere the toner permanently. The final stage is to clean the drum 42 of any remnants of toner utilizing a cleaning system 54, ready for the cycle to start again.

FIG. 3 is a block diagram illustrating the printer controller 60 shown in FIG. 2. The printer in FIG. 3 is a laser printer. This is illustrative only. The present invention includes other types of printers with printer controllers 60 providing similar functionality. The printer controller 60 is utilized to control the printer engine 41. The printer controller 60 has a processor 62 coupled via a bus 66 to a memory 64. The processor 62 may be a custom microcontroller, or a commodity microprocessor. The processor 62 in one embodiment is a MIPS RISC processor. However, other types of processors are also within the scope of this invention. The memory 64 preferably includes a combination of volatile memories such as DRAM and SRAM and non-volatile memories such as Flash or EEPROM memories.

Also coupled to the bus 66 is the printer engine 41 and a communications interface 68. The printer controller 60 controls the operation of the printer engine 41, including controlling operation of the laser 44, mirrors 46, and paper feed. The communications interface 68 is coupled to one or more communications links 69. Typical types of communications links 69 are an RS-232 Centronics interface or a network interface, such as Ethernet. Other types of communications links 69 and interfaces 68 are also within the scope of this invention. In one embodiment, the communications links 69 are bidirectional, with printer commands being transmitted to a printer and status information sent back to a computer issuing the printer commands.

A laser printer 40 was illustrated in the previous FIGs. This is illustrative only. Other output devices are also within the scope of this invention, including ink jet printers and All-in-One systems capable of printing, scanning, faxing, etc.

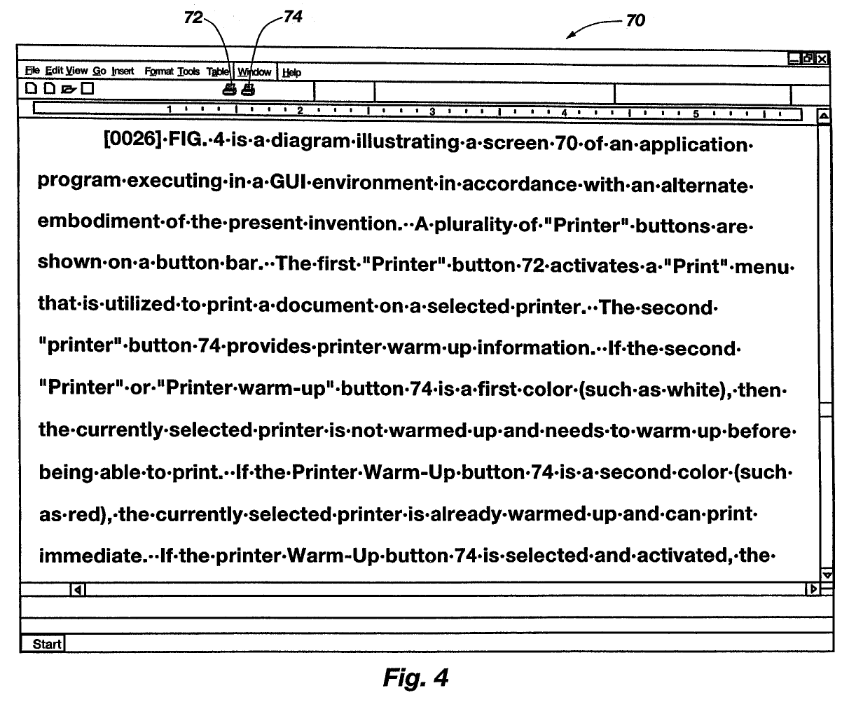

FIG. 4 is a diagram illustrating GUI environment desktop screen 70 showing an application program executing in a GUI environment, in accordance with another embodiment of the present invention. A plurality of “Print” buttons is shown on a button bar. The first “Print” button 72 activates a “Print” menu that is utilized to print a document on a selected printer. The second “Print” button 74 provides printer warm-up information. If the second “Print” or “Printer Warm-Up” button 74 is a first color (such as green or gray), then the currently selected printer is not warmed up and needs to warm up before being able to print. If the Printer Warm-Up button 74 is a second color (such as red), the currently selected printer is already warmed up and can print immediate. If the Printer Warm-Up button 74 is selected and activated, the currently selected printer starts to warm up if it is not already warmed up. The color of the Printer Warm-Up button 74 will then change to the second color when the printer has warmed up.

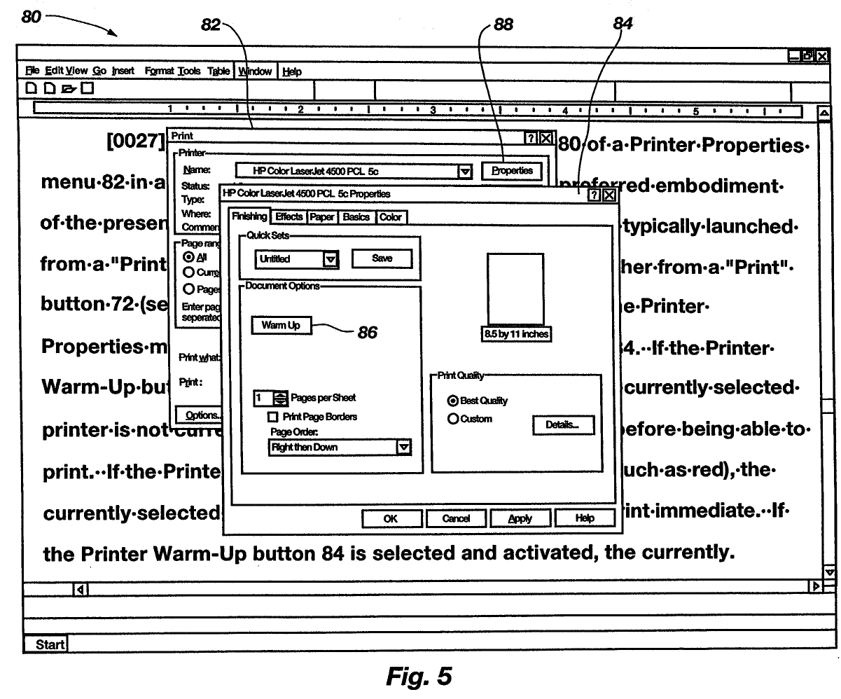

FIG. 5 is a diagram illustrating a GUI environment desktop screen 80 showing a Printer Properties menu 84, in accordance with one embodiment of the present invention. The Printer Properties menu 84 is typically launched by selecting and activating a “Properties” button 88 on a “Print” menu 82, which in turn is typically launched either by selecting and activating a “Print” button 72 (see FIG. 4) or from a “File” pull-down menu. The Printer Properties menu 84 includes a “Printer Warm-Up” button 86. If the Printer Warm-Up button 86 is a first color (such as green), then the currently selected printer is not currently warmed up and needs to warm up before being able to print. If the Printer Warm-Up button 86 is a second color (such as red), the currently selected printer is already warmed up and can print immediately. If the Printer Warm-Up button 86 is selected and activated, the currently selected printer starts to warm up if it is not already warmed up. The color of the Printer Warm-Up button 86 will then change to the second color when the printer has warmed up.

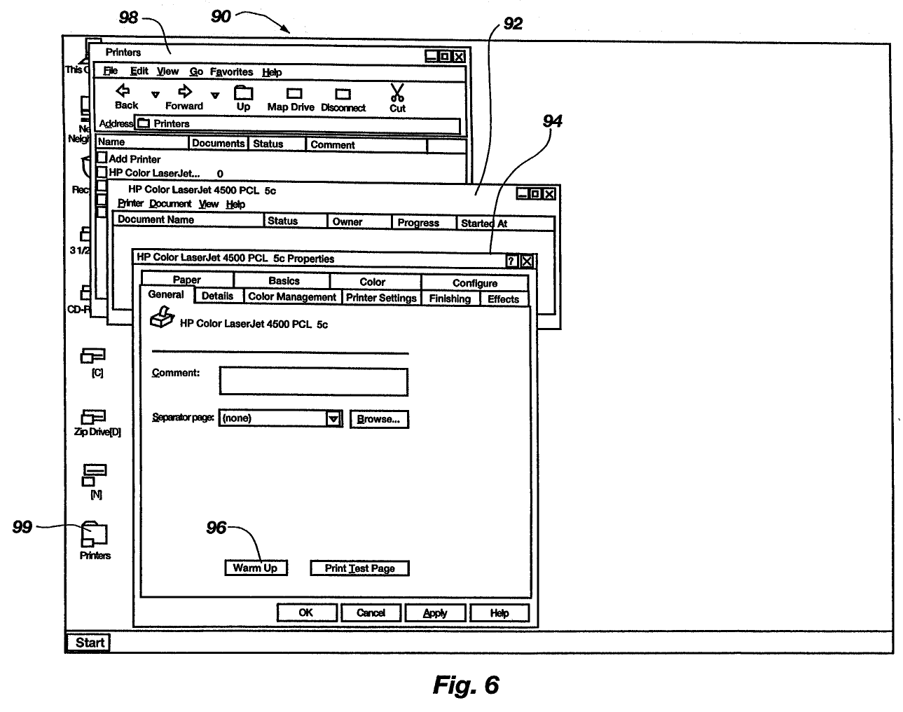

FIG. 6 is a diagram illustrating GUI environment desktop screen 90 showing a Printer Properties menu 94, in accordance with an embodiment of the present invention. This Printer Properties menu 94 is typically launched from a “Printer” menu 92, which in turn is typically launched from a “Printers” menu 98, which in turn is typically launched by selecting and activating a “Printers” icon 99 on the GUI desktop screen 90. The Printer Properties menu 94 includes a “Printer Warm-Up” button 96. If the Printer Warm-Up button 96 is a first color (such as green), then the currently selected printer is not currently warmed up and needs to warm up before being able to print. If the Printer Warm-Up button 96 is a second color (such as red), the currently selected printer is already warmed up and can print immediately. If the Printer Warm-Up button 96 is selected and activated, the currently selected printer starts to warm up if it is not already warmed up. The color of the Printer Warm-Up button 96 will then change to the second color when the printer has warmed up.

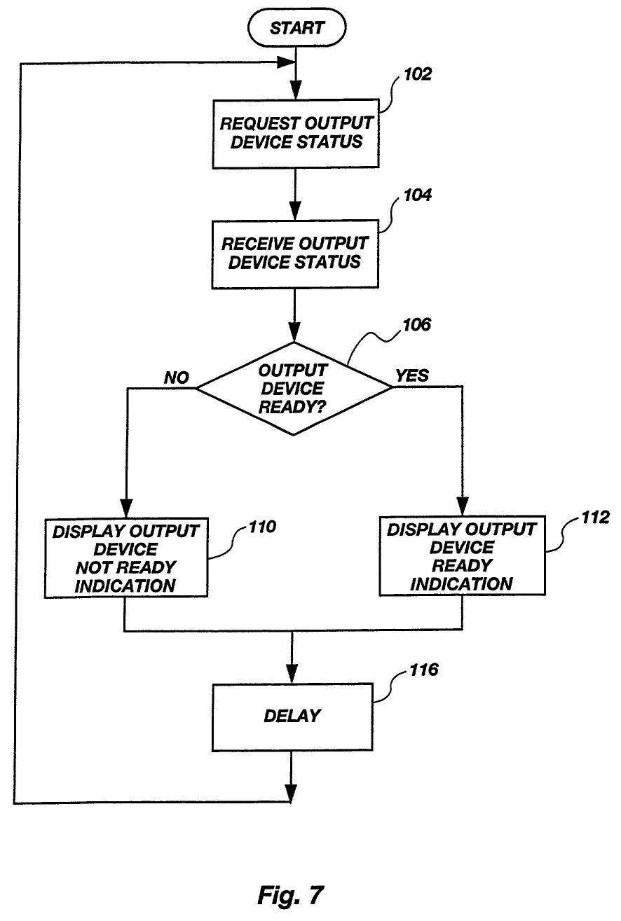

FIG. 7 is a flowchart illustrating an implementation of the present invention. It starts by entering a loop. A request is made to an output device for its current status, step 102. The output device then responds with its current status, step 104, in particular, whether or not it can currently print. A test is then made, based on the status information received, to determine whether the output device is currently able to print, step 106. If the output device is not ready to print, step 106, an indication is displayed to a user that the output device is not ready to print, step 110. Otherwise, an indication is displayed to the user that the output device is ready to print, step 112. Then, a delay is performed, step 116, and the loop then repeats, starting with the request for the output device status, step 102.

In the embodiments shown in FIGS. 4, 5, and 6, the indications whether or not the output device is ready to print are presented to a user as different colored buttons. For example, green can be used to indicate that the output device is ready to print, and red to indicate the opposite. However, other indications are also within the scope of this invention, including the usage of different buttons for the two situations. For example, the case of the output device not being ready for printing could be indicated by a button showing a printer with a line through it. Also, the term “button” is utilized throughout this description. This is illustrative of one embodiment. Other GUI constructs, such as icons, can be utilized in a similar manner within the scope of this invention.

In the embodiment shown in FIG. 7, the readiness of the output device to print is determined by periodically probing the output device. One alternative is to have the output device transmit print status information to the computer being used by the user without being probed. These spontaneously generated status messages can be generated on a periodic basis and when the status of the output device changes, such as when an output device finally warms up sufficiently to print.

Those skilled in the art will recognize that modifications and variations can be made without departing from the spirit of the invention. Therefore, it is intended that this invention encompass all such variations and modifications as fall within the scope of the appended claims.

What is claimed is:

1. A method for informing a user in a GUI environment whether an output device is currently ready for printing comprising:
determining whether the output device is ready for printing;
providing a first indication to the user if the output device is not ready for printing; and
providing a second indication to the user if the output device is ready for printing.

2. The method in claim 1 wherein:
providing the first indication comprises presenting a button in a first color; and
providing the second indication comprises presenting the button in a second color.

3. The method in claim 2 wherein:
presenting the button comprises presenting the button on an application button bar.

4. The method in claim 2 wherein:
presenting the butt on comprises presenting the button on a printer properties menu.

5. The method in claim 1 wherein:
the method further comprises:
receiving a status indication from the output device; and
the determining whether the output device is ready for printing comprises utilizing the status indication.

6. The method in claim 5, further comprising:
requesting the status indication from the output device.

7. The method in claim 1 wherein:
providing the first indication comprises presenting a first button; and
providing the second indication comprises presenting a second button.

8. The method in claim 1, further comprising:
accepting a request to ready the output device for printing; and
notifying the output device to become ready for printing.

9. The method in claim 8, further comprising:
receiving a notification from the output device that the output device is ready for printing.

10. The method in claim 9, further comprising:
providing the second indication to the user in response to receiving the notification from the output device that the output device is ready for printing.

11. A system configured to inform a user in a GUI environment whether an output device is currently ready for printing comprising:
a computer instruction storage medium containing:
a set of computer instructions for determining whether the output device is ready for printing;
a set of computer instructions for providing a first indication to the user if the output device is not ready for printing; and
a set of computer instructions for providing a second indication to the user if the output device is ready for printing.

12. The system in claim 11 wherein:
the set of computer instructions for providing the first indication comprises a set of computer instructions for presenting a button in a first color; and
the set of computer instructions for providing the second indication comprises a set of computer instructions for presenting the button in a second color.

13. The system in claim 12 wherein:
the sets of computer instructions for presenting the button comprise computer instructions for presenting the button on an application button bar.

14. The system in claim 12 wherein:
the sets of computer instructions for presenting the button comprise computer instructions for presenting the button on a printer properties menu.

15. The system in claim 11 wherein:
the computer instruction storage medium further contains:
a set of computer instructions for receiving a status indication from the output device; and
the set of computer instructions for determining whether the output device is ready for printing comprises computer instructions utilizing the status indication.

16. The system in claim 15 wherein the computer instruction storage medium further contains:
a set of computer instructions for requesting the status indication from the output device.

17. The method in claim 11 wherein:
the set of computer instructions for computer instructions for providing the first indication comprises a set of computer instructions for presenting a first button; and
the set of computer instructions for providing the second indication comprises a set of computer instructions for presenting a second button.

18. The system in claim 11 wherein the computer instruction storage medium further contains:
a set of computer instructions for accepting a request to ready the output device for printing; and
a set of computer instructions for notifying the output device to become ready for printing.

19. The system in claim 18 wherein the computer instruction storage medium further contains:
a set of computer instructions for receiving a notification from the output device that the output device is ready for printing.

20. A computer readable medium containing computer instructions for:
determining whether an output device is ready for printing;
providing a first indication to a user if the output device is not ready for printing; and
providing a second indication to the user if the output device is ready for printing.
